(19) United States
(12) Patent Application Publication
(10) Pub. No.: US 2010/0062849 A1
(43) Pub. Date: Mar. 11, 2010

(54) Method for creating and releasing video games with movie machinima and creating interactive educational machinima of the great books and classics

(75) Inventor: Elliot McGucken, Malibu, CA (US)

Correspondence Address: DR. ELLIOT MCGUCKEN, 23852 PCH, #971, MALIBU, CA, 90265, US

(73) Assignee: ELLIOT MCGUCKEN, MALIBU, CA (US)

(21) Appl. No.: 12/283,108

(22) Filed: Sep. 8, 2008

(51) Int. Cl. A63F 13/00

(52) U.S. Cl. 463/31

(57) ABSTRACT

Opportunity abounds for machinima, games, and worlds based upon the Great Books and Classics, epic films, and historical events. Machinima, video games, and virtual worlds lack character, soul, and story, as has been well-documented throughout the literature and in prior art. A novel form of machinima and virtual worlds loyally based on Great Books is envisioned, as well as a novel manner for releasing video games based on movies with complete machinima renderings of the films the games are based on. A method for allowing players or viewers to view the action, from great books or films, from all angles and interact with it is proposed. Commercial, artistic, educational, actor-training, and other exalted opportunities will abound as soulful machinima and worlds based upon the classics are realized, beginning with machinima loyal to epic stories, and allowing a spectrum of player interactions, where the player's ideas and actions have varying consequences.

### CROSS-REFERENCE TO RELATED APPLICATIONS

This application claims the benefit of provisional patent Ser. No. ______ filed Sep. 8, 2007 by the present inventor.

This application claims the benefit of patent application Ser. No. 20070087798 filed Oct. 12, 2006 by the present inventor, and patent application Ser. No. ______ filed Jul. 11, 2008 by the present inventor.

### FEDERALLY SPONSORED RESEARCH

Not Applicable

### SEQUENCE LISTING OR PROGRAM

Not Applicable

### INTRODUCTION

### Field of the Invention

This invention pertains to machinima, virtual worlds, and video games, and more particularly to video games, virtual worlds, and machinima that bring the Great Books and Classics to life.

### SUMMARY OF THE INVENTION

This invention pertains to machinima, virtual worlds, and video games, and more particularly to video games, virtual worlds, and machinima that bring the Great Books and Classics to life. This invention also pertains to a novel way of releasing video games based on movies, wherein the video game contains an entire version of the movie in machinima, and wherein the player can watch the entire course of the movie in addition to playing the game. Other embodiments would allow the player to interact with the machinima in various manners and at various plot points, resulting in more-engaging gameplay which will deliver artistic experiences closer to the film's. Players will be able to enter and exit dramatic works of art as they see fit, including classic, epic films and the Great Books. Players and their friends, or actors and actresses could select different roles to play, and the game could be set to different levels corresponding to how far from the traditional plot players are allowed to ramble.

### FURTHER BACKGROUND AND SUMMARY OF THE INVENTION

While video games and machinima abound in variation and scope, there has yet to be a great book or classic presented in machinima. There are video games loosely based on classics such as The Odyssey and Dante's Inferno, but there exists no machinima that is completely loyal to a classic, including the text and/or imagery of the classic, nor the full text and imagery of the classic. The current invention proposes machinima based on the full version of classics such as Hamlet and Dante's Inferno. Such an innovation would have great and novel consequences in the realms of education and entertainment. Furthermore, it would allow designers and animators to hone their skills when it comes to rendering expressions, as we all know how Hamlet ought look when he's contemplating suicide—just look at Sir Lawrence Olivier. Furthermore, such a novel invention would provide a mechanism for actors and actresses to practice their lines by taking the role of one of the characters in the machinima. Furthermore, such a novel invention would allow the viewers, students, and/or players to explore classical worlds, interact with classical characters, and experience the consequences of their words and deeds. Such a system could provide a novel and extremely beneficial educational tool.

Imagine machinima representing the American Revolution or the Civil War. Battles could be watched from all angles and on all sides, and in various embodiments. And too, the student could be called upon to act in the battle, as a general or member of the infantry or in some other capacity, for example. The student could be called upon to address and inspire soldiers, choosing the correct historical dialogue. The present invention proposes providing both 1) machinima of the actual event and/or battle that could be viewed from a multitude of angles and 2) a platform wherein a player can interact with the machinima and effect the outcome.

The present invention suggests a novel way for packaging selling movies and video games based on said movies. Imagine if the video game contained the movie in the mahcinima. To date, this has not been seen. For example, one can purchase the Iron Man video game, or Batman video game, or Fantastic Four video game, or Spider Man video game, or Star Wars video game, but the video game does not contain the movie. There is no machinima representation of the movie. Nor is there a machinima form of the movie one can choose to 1) either watch or 2) interact with. Such a novel innovation would provide enhanced gameplay, as one would be put in the character's shoes, and one would see if one was tough enough or moral enough or fast enough to deliver. As movies are generally far more narratively developed than video games, such a system will lead to video games with enhanced narratives. Also, as it is well-known that video games based on movies are often lackluster, or that they outright suck, such a system would allow improved video games based on movies, as one would be ensured more of the film's emotional depth. As voice recognition and AI advanced, the video game worlds could become more and more real, allowing a full spectrum of experiences, ranging from watching a machinima version of the movie straight on through, to changing the course of the plot and the character's destiny. Such methods for altering the plot, based on moral premises and ideas and actions that have consequences, are discussed in earlier patent applications authored by Dr. Elliot McGucken, included in the cross-references.

The present invention offers a way in which to present games with superior soul and spirit, and more exalted storytelling. In order to ensure exalted story, why not establish a brand that packages the video game with a machinima version of the movie. Imagine getting to select and play and partake in your favorite scenes in a movie! Such a system would provide novel and enhanced entertainment opportunities for consumers. Imagine not just playing a slapdash game based on Batman™, or Spiderman™, or The Man with No Name, but becoming them.

Imagine Shakespeare's Hamlet or Dante's Inferno rendered in Machinima. A user could view The Inferno or Hamlet from any angle. Over time, as AI improved, the user would be able to interact with the characters and influence the plot.

To date, one cannot enjoy a Machinima rendering of The Odyssey, nor Dante's Inferno, nor Shakespeare's Hamlet, nor The Book of Matthew, nor Socrates' Apology. machinima developed to be 100% loyal to such works would stand head and shoulders above the current machinima. Furthermore, because we are already familiar with Hamlet's emotions, such machinima would allow a calibration of emotive software and the technology that controls facial expressions and software. In addition to becoming a “fly on the wall” in the virtual world of Hamlet, watching the action from every possible vantage point, the player will also be afforded the opportunity of interacting with the characters. The player could introduce a brand new player, or they could take on the role of the lead character or a minor, smaller character. As voice recognition technologies advanced, the player could actually speak to the characters in the game world and interact with them. As voice recognition, AI, and understanding technologies advanced, the character could influence the outcome of the plays. Such a system could allow actors and actresses to hone their lines, as well as experience the thrill of playing a part in a classic work of literature. A virtual reality helmet could be introduced, so as to fully immerse the player in the world.

### PRIOR ART

Dr. Elliot McGucken covers the prior art in video games in several earlier preliminary and utility patent applications, where he details the soullessness, characterlessness, and storylessness of games, as well the absence of the industry to admit this, and instead hype, hype, hype storylessness as story. The provisional and utility applications are included in the cross-references above. The patent applications can be readily viewed online, and this current patent also seeks to exalt epic art, story, and soul in video games in an extended manner.

In the August 2008 Edge Magazine, Ralph Eggleston of Pixar was recently interviewed in http://www.edge-online.com/magazine/interview-how-gaming % E2%80%99s-affecting-pixar:

EDGE: But obviously the gap is closing as technology moves forward on the gaming front.
EGGLESTON: Yes, I think it will get better and better. But for me, the big thing lacking in videogames, and I haven't seen one that has done this for me, is how you involve a strong narrative story. Not just a set-up that you jump in to, but a narrative story in which the player is an active participant. I've had this conversation with friends now for almost a decade on how you could actually do that with a videogame. Unfortunately, although I think there would be a market for that, I don't think the market would be large enough.
EDGE: But obviously the gap is closing as technology moves forward on the gaming front.
EGGLESTON: Yes, I think it will get better and better. But for me, the big thing lacking in videogames, and I haven't seen one that has done this for me, is how you involve a strong narrative story. Not just a set-up that you jump in to, but a narrative story in which the player is an active participant. I've had this conversation with friends now for almost a decade on how you could actually do that with a videogame. Unfortunately, although I think there would be a market for that, I don't think the market would be large enough. http://www.edge-online.com/magazine/interview-how-gaming % E2%80%99s-affecting-pixar

The present invention contends that the market for games with stories and deeper emotions and feelings would be huge, and thus it counters expert opinion. Video games and machinima have failed to deliver exalted narrative stories, and thus exalted souls and spirits, as story is soul's flagship, but the new invention, inspired by Dr. Martin Luther King Jr.'s words, would present a new realm of video games by going on back to the classics.

### A BRIEF DESCRIPTION OF THE DRAWINGS

FIG. 1 depicts a machinima display wherein a Great Books or Classic can be watched from any angle.

FIG. 2 depicts a machinima display/game wherein a character can play different roles in the machinima.

FIG. 3 depicts a machinima setup that is based on a film or book in which a player can jump in and jump out, playing their favorite scenes. If they fail to perform, they may never get to see the end. Or, they may be able to watch the scene again.

### DETAILED DESCRIPTION OF EMBODIMENTS OF THE INVENTION

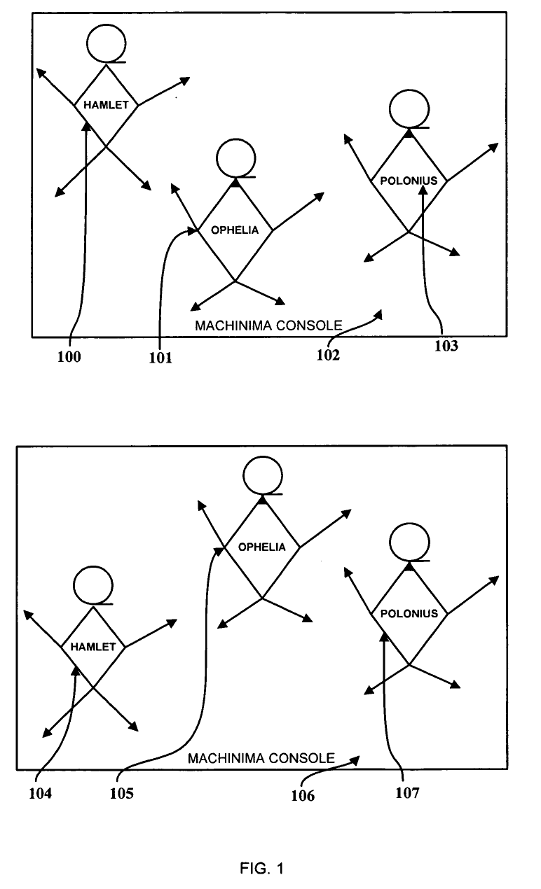

FIG. 1 depicts a machinima display wherein a Great Books or Classic can be watched from any angle, resulting in enhanced educational opportunities. A Machinima rendition of Hamlet takes place in which a scene involves Hamlet (100), Ophelia (101), and Polonius (103), although this could be any classic. The play is viewed on the Machinima console (102). The angle can be changed in (106) so that the player can watch the action from a different angle.

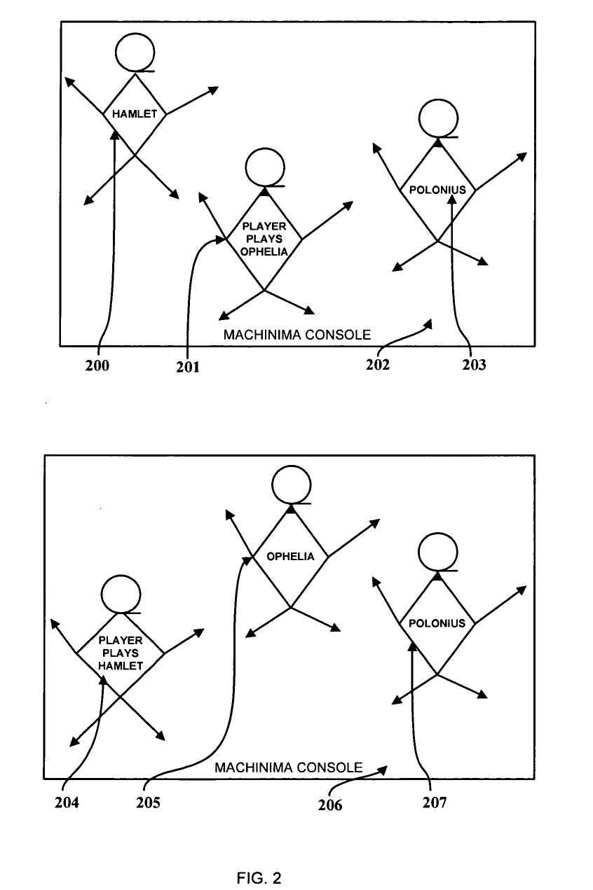

FIG. 2 depicts a machinima display/game wherein a character can play different roles in the machinima, thusly providing novel educational opportunities as well as manners for training actors and actresses. A Machinima rendition of Hamlet takes place in which a scene involves Hamlet (200), Ophelia (201), and Polonius (203), although this could be any classic. In one version, shown on the console (202), a player chooses to play as Ophelia (201), providing her lines and or dialogue via a menu, a game controller, a keyboard and mouse, a voice, or some combination thereof. On console (206), the player chooses to play Hamlet (204), providing his lines and or dialogue via a menu, a game controller, a keyboard and mouse, a voice, or some combination thereof. The plot could advance relative to the player's success in providing the correct lines. Students could be graded via this method, and actors and actresses could train by this method. Any classic could be rendered in this way, resulting in one that showed Dante walking through hell, and also allowed one to interact with him. Any play or film could be taught in this manner, and actors could train with the software to a more and more advanced degree as voice recognition and AI advanced. Combined with previous inventions filed by Dr. E, ideas could be shown to have consequences, and moral premises could guide the plot development. As shown in the next figure, players could take the action in brand new directions, and they could perhaps pop in and pop out at will, playing in their favorite scenes or in the scenes they are training for.

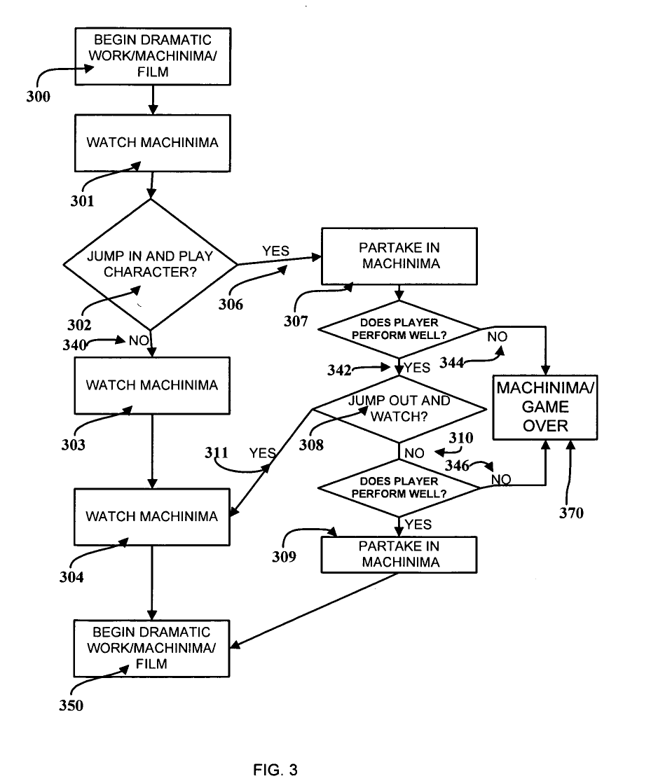

FIG. 3 depicts a machinima setup that is based on a film or book in which a player can jump in and jump out, playing their favorite scenes. If they fail to perform, they may never get to see the end. Or, they may be able to watch the scene again. FIG. 3 suggests a brand new way of creating and selling video games, as fully independent machinima renditions of a dramatic work, complete with options to jump in and out of the action. Such a system could lead to maverick art forms and methods for packaging and selling games.

A machinima rendition of a dramatic work or film or movie begins (300). The original movie may very well be a machinima production. The player or viewer watches the machinima (301) and they reach a plot point where they have the option to jump in and play a character (302). If they choose not play a character, they continue watching (340) the Machinima 303, 304, until the end (350). If they choose (306) to partake in the Machinima (307) they will be called upon to act or speak or behave as the character (307). If they do not perform well (344), the game/machinima ends (370). If they perform well, then they advance (342) and the plot advances. At this point they can choose to jump out and watch (308). If they choose to jump out and watch (311), they can continue watching (304) unto the very end (350). If they choose at (308) to continue playing a part (310), they are again tested by the gameplay. If they perform well, then they get to partake in the Machinima (309). If they perform poorly (346), then the game/machinima ends.

The above could be envisioned with rewinds, fast forwards and jumping in at will, or it could be set up so that one has to earn the right to play scenes by winning previous scenes in a chronological order.

Now all of the above can be combined with standard machinima and gameplay protocols, as well as innovations described in earlier inventions and patent applications filed by Dr. Elliot McGucken.

The present invention could be realized by an individual, or a small team, skilled in the realm of game development and machinima creations. The present invention would be built on similar systems disclosed in earlier patent applications filed by Dr. Elliot McGucken, including the application for the Ideas Have Consequences Engine and Morality Level Meter patent application Ser. No. 20070087798 filed Oct. 12, 2006, which discloses the mechanism of a video game system. Tools for creating machinima are readily accessible and always advancing, and they may be found at machinima.com.

### FURTHER OBJECTS AND ADVANTAGES OF INVENTION

The present invention would afford:
1. Educational machinima and/or video games that allow the player to play a part in a classical play or work of literature, allowing them to memorize and hone lines.
2. Educational machinima and/or video games that allow the player to modify a part in a classical play or work of literature, allowing them to witness alternative endings based upon algorithms presented in the former “ideas have consequences” manifestation of this invention.
3. Educational machinima that for the first time allows the viewer to view the Great Books form all angles.
4. An enhanced mechanism for creating and selling games based on movies, by including a machinima rendition of the movie in the game, so that the player might be able to dive in at key plot points and try their hand at participating in the action. This novel, hybrid form of entertainment may be watched and enjoyed by others, to the point where members of a film audience could partake in the movie being projected!
5. Machinima used to train and exalt actors.
6. Virtual worlds based on great books or films wherein one or more people could take on the roles of the characters, for instance in a romantic comedy, and taking the plot in brand new directions.

### CLASSICAL BACKGROUND OF THE INVENTION AND FURTHER EMBODIMENTS

Jefferson suggested that we turn towards the Founding Father's original intent when interpreting the Constitution, and thus it is imperative that machinima and video games embrace the Great Books and Classics, in this day and age whence the Constitution is imperiled. Imagine machinima embodying all of the classics below.

As the winds shift in the financial world, again opposing the prevailing winds in that higher, ethereal realm, perhaps it's time to turn towards a greater, more-enduring investment—a classical liberal arts education. The Great Books have been hedged against and shorted in all realms, along with classical honor, character, and integrity, and now is a great time to buy in. All the classics in my Hero's Journey in Artistic Entrepreneurship & Technology class can be purchased for less than the typical textbook—most can be downloaded for free—and the ideals contained within their pages will last a lifetime, providing sublime mentorship in all endeavors. There is no higher adventure than sailing forth with the greatest that has been written and spoken, and passage alongside the fellowship of immortal souls is as free as the truth's wind, which shall rise again in a Great Books renaissance, exalting the classics to new heights in living ventures—in novels, films, video games, classes, labs, and institutions—in the American Soul. The novel form of machinima presented in this invention will serve the rising need of machinima and interactive video games based on the Great Books and classics, paying off in dividends.

The class follows the hero's journey made famous by Joseph Campbell, and our first mentor, John C. Bogle, the founder and former CEO of Vanguard, calls us to adventure with The Battle for The Soul of Capitalism, which we read alongside Horner's Odyssey. Odysseus forgoes staying forever young with a goddess and resists the Sirens and Lotus Eaters to return on home to his beloved Penelope, who remains faithful during his twenty-year absence—imagine a video game that brought this depth of character to life. Odysseus cleans house of the false suitors who have been laying his estate to waste and states, “Go forth and tell all that fair dealing leads to greater profit in the end,” and Bogle agrees—“For better or worse, my youthful idealism—the belief that any truly sound business endeavor must be built on a strong moral foundation—still remains today.” Just as Odysseus dispatched the false suitors, Bogle “strung the bow” and eliminated the mutual fund “managerial capitalist” middlemen from the unique index fund structure, resulting in the innovative Vanguard Group and superior long-term returns for millions of clients. The novel form of machinima presented in this invention will serve the rising need of machinima and interactive video games based on the Great Books and classics, paying off in dividends, as classical principle pervaded both The Odyssey and Vanguard.

The eternal principles of screenwriting, business, and law; of art, entrepreneurship, and technology, derive from Epic Story—the source of the soul. Moses came not out of a Starbucks with the Ten Commandments, but he came down from a mountain. Melville warns us of the soul-stultifying, dream-killing corporate cubicles that Neo escapes in The Matrix: “But these are all landsmen; of week days pent up in lath and plaster—tied to counters, nailed to benches, clinched to desks.” Odysseus gained his home not by securitizing sub-prime loans while “nailed to a desk” in a law firm, privatizing profits and socializing risk with fine print, but by braving the open ocean and defeating the Cyclops—the one-eyed giant that walked around like our postmodern Wall Street, eating the common man's pensions, investments, and savings, one by one. Bogle writes about capitalism's transmogrified giant: “We begin with an analysis of what went wrong in corporate America, reflected in a pathological mutation from traditional owner's capitalism to a new form, manager's capitalism . . . . The markets had so diffused corporate ownership that no responsible owner exists. This is morally unacceptable, but also a corruption of capitalism itself.” And too, in addition to the giant of corporate corruption aligned against the common investor, when adjusted for inflation, the Dow has been declining over the past ten years. And when adjusted for cultural inflation, wherein monetary inflation may be temporarily hid, the Dow has been declining for far longer. For whereas a single worker could once support a family on a single salary, some say that it now takes two workers, whereas others report that this is of no concern, as the family—about which G. K. Chesterton stated, “(the family) is the test of freedom; because the family is the only thing that the free man makes for himself and by himself”—is on its way out. The novel form of machinima presented in this invention will serve the rising need of machinima and interactive video games based on the Great Books and classics, paying off in dividends, as classical principle pervaded both The Odyssey and Vanguard.

And so we head for Epic Romance of the Divine Comedy, where Dante walks through hell to be with Beatrice, for every hero's journey, be it Odysseus, Dante, William Wallace, or King Leonidas, is ultimately a love story, as Leonidas's 1st words are, “my wife, my queen, my love.” For shat else, truly, is there? And so we head for the wild waves and wilderness of entrepreneurial ventures, where one makes things “for himself and by himself,” fostering a government of the people, by the people, and for the people. We sign aboard for a greater adventure, where one gets to own their sweat equity—their very life and dreams—and where, like the knights of King Arthur's Court, each student must find their own path through the forest in an independent project—the forest where Dante also begins—“Midway through the journey of my life, I found myself in a dark wood.” And the students all agree—America needs a bold, rugged form of leadership to guide us out of this dark wood. The novel form of machinima presented in this invention will serve the rising need of machinima and interactive video games based on the Great Books and classics, paying off in dividends, as classical principle pervaded both The Odyssey and Vanguard.

Martin Luther King Jr. presents the class's motivation, “If we are to go forward, we must go back and rediscover those precious values—that all reality hinges on moral foundations and that all reality has spiritual control.” Thomas Jefferson agrees, writing in his later years, “They all fall away, one by one, until one is left with Virgil and Horner, and perhaps Horner alone.” We must read the Greats not for tenure and titles, but so as to render their ideals real in living ventures, as the Founding Fathers did in the Constitution and Bogle did in Vanguard. As freedom requires eternal vigilance, and as for evil to triumph all good men must do is nothing, the classical ideals must be perpetually performed in the living context via action—via matching exalted word with exalted deed, as all the enduring poets and prophets agreed. The novel form of machinima presented in this invention will serve the rising need of machinima and interactive video games based on the Great Books and classics, while exalting higher art and paying off in dividends.

We turn to Socrates' Apology for a most fundamental lesson in economics and courage, which ought be reunited, “I tell you that virtue is not given by money, but that from virtue comes money and every other good of man, public as well as private. This is my teaching, and if this is the doctrine which corrupts the youth . . . acquit me or not, but understand that I shall never alter my ways, not even if I have to die many times.” Plato's parable of the cave explains the financial wealth-transfer bubbles we've been enduring as of late, as Socrates notes that while those who see the truth beyond the shadows are of exiled and silenced, the Jim Cramers and Henry Blodgets are adulated as wise men and well compensated for expert commentary on what ultimately amounts to mere dancing, fleeting shadows—the daily market fluctuations that are largely ignored by investment giants including Buffet and Bogle. While Buffet became a billionaire by investing in individual stocks (companies) for “eternity,” and while Bogle created a trillion-dollar institution by indexing across the broad market (for eternity), both frown upon the short-term gambling that Wall Street glorifies, as the house always wins. Bogle writes in Battle, “When we should be teaching young students about long-term investing and the magic of compound interest, the stock-picking contests offered by our schools are in fact teaching them about short-term speculation. And the biggest financial circus of all-today's incarnation of the Circus Maximus, is the garish eight-story NASDAQ MarketSite Tower in Times Square, displaying stock prices on what is proudly billed as the “world's largest video screen.” That display, it seems to me, is the visual paradigm of a stock market that has become not only a circus, but a casino for speculators. Yet as Lord Keynes warned us: “When the capital development of a country becomes the product of the activities of a casino, the job is likely to be ill-done.”

And so the class turns away from the casino's bright lights and windowless rooms, and towards those greater adventures on the Western frontier the spirit yearns for. Given classical tools and a more exalted context, students naturally turn towards rendering ideals real in innovation, towards rugged, responsible risk-taking in the service of their peers, where they, and not the house, pocket the vast returns of the pursuit of honor in this fleeting life—of the creators' blood, sweat, and tears. They turn towards epic entrepreneurship—serving the rising demand for classical art and entities. Speaking poetry to power has ever marked a most dangerous journey, as Dante, Socrates, and Jesus were exiled, sentenced to death, and crucified. But yet, the students read Benjamin Franklin's autobiography and see his thirteenth and final precept saluting the prophetic heroes to whose words and actions we ultimately owe the soul of the democratic republic the Founders gifted us, which many see fading into a bankrupt empire—Franklin's thirteenth precept is: Humility: Imitate Socrates and Jesus. And indeed, when I approached teaching a course on entrepreneurship with humility, I ended up teaching a Great Books class, for I could find no greater mentors, no greater leaders, no greater value, and no greater foundation for the “Wealth of Nations.” Irony of all ironies that the Great Books, largely exiled by the humanities departments, made their way on back, by popular student demand, in Artistic Entrepreneurship & Technology, which was UNC's largest and most-requested class on entrepreneurship ever offered, and which received perfect scores in student evaluations in its most recent inception, three years later in California. But the credit goes not to me, but to the Greats. The novel form of machinima presented in this invention will serve the rising need for machinima and interactive video games based on the Great Books and classics while exalting higher art, paying off in dividends.

For when it comes to brands and branding, what brand has outlasted Horner's Iliad and Odyssey? Surely then, the classics are worth contemplating by every student of marketing-how is it that Horner comes down to us through the millennia? What crucial aspect inhabits the spirit of his work? When it comes to communications, what professor has improved upon Shakespeare, who gave “the airy-nothingness of our consciousness a local habitation and a name?” When it comes to long-term value, what committee has improved upon the biblical poets and prophets? When it comes to making numbers add up, should we not study Newton and Pythagoras instead of the MBAs who brought us thousands of Enrons? When it comes to Political Science, what candidate has surpassed The Declaration of Independence? Surely the MBA interested in learning how to value companies ought contemplate Warren Buffet, who invests for eternity, as well as William Blake who wrote for eternity:

### To see a World in a Grain of Sand

### And a Heaven in a Wild Flower,

Hold Infinity in the palm of your hand
And Eternity in an hour.
When it comes to teaching leadership, can we do better than Moses parting the sea and leading his people to freedom, or Captain Ahab leading his crew in pursuit not of mere money, but of that “which cannot be counted down in dollars from the mint?” When it comes to economics, can we find greater lessons than those taught by Thoreau who stated, “a man is rich in proportion to the number of things he can afford to let alone?” Or Plato, “All the gold which is under or upon the earth is not enough to give in exchange for virtue.” Or Ralph Waldo Emerson:
Not gold but only men can make
A people great and strong;
Men who for truth and honor's sake
STAND fast and suffer long.
Brave men who work while others sleep
Who dare while others fly—
They build a nation's pillars deep,
And lift them to the sky.

### Ralph Waldo Emerson

Reading Jefferson's Declaration of Independence and Franklin et al's. Constitution, we see that America was founded as a place where Dante, Socrates, and Jesus—and all the prophetic poets who came before and hence-would be not persecuted, but honored with the freedom of speech and Natural Rights their Creator endowed them with. For the Founders recognized that truth and intellectual freedom—not PR, political hype, and mysticism—are the true founts of long-term wealth—of enduring peace and prosperity. Engraved high up in the Jefferson Monument is the essence of his hero's journey, “I have sworn upon the altar of god eternal hostility against every form of tyranny over the mind of man.” Bold, exalting words from an heroic age the students are longing for. The novel form of machinima presented in this invention will serve the rising need for machinima and interactive video games exalting epic art, paying off in dividends.

In Aristotle's Poetics, plot and character are ranked first, and music and spectacle last, and the class notes that modern Hollywood, Wall Street, and politics honor the original literary critic's order as the exception as opposed to the rule. Aristotle writes, “history tells us as things are, while story tells us the way things ought to be,” thusly exalting epic poetry over today's reality TV. Odysseus ought return on home to Penelope, and Penelope ought remain faithful to him, the students all agree, as they will soon graduate facing a 50% divorce rate. Not only have our schools been failing to teach how to properly price a house, but they have been failing to teach the infinite value of the home. The novel form of machinima presented in this invention will serve the rising need for machinima and interactive video games based on the Great Books and classics, paying off in dividends.

Many students will also graduate with vast and unprecedented debt, and thus they enjoy the seventh circle of hell where Dante places the sub-prime usurers and the college-loan programs that kick back profits to university administrators, who never step foot in a classroom to serve the students, as tuitions skyrocket, placing immense pressures and stress on the students' future marriages, ventures, and freedom. We read the Inferno and contemplate a video game based on its nine levels, set to Beethoven's nine symphonies. Imagine battling Satan to Beethoven's Ninth to save exalted Beatrice, instead of jacking cars and killing cops and hookers as so many are left to do in today's most popular game—Grand Theft Auto—the bestselling game of all time, but only because the classical epics are actively deconstructed, and thus have not been given a fair chance in our era, until now. The novel form of machinima presented in this invention will serve the rising need for machinima and interactive video games exalting higher art, paying off in dividends. There is a longing for art exalted far above Grand Theft Auto.

Aristotle writes, “when storytelling declines, the result is decadence,” and we discuss how culture and society have been declining alongside the general expulsion of the Greats from the University. There is a vast and growing demand for classical idealism amongst the students—it seems they are yet showing up to college with immortal souls. Ideas have consequences, and gaming, like the students, came of age where classical ideals were of opposed in the popular culture and on university campuses, so as to exalt the bottom line over the higher ideals. But one cannot hedge against eternity forever, and the games of the Great Books Renaissance will trump today's games, allowing players to match heroic ideas with heroic actions in virtual worlds exalting Homeric and Aristotlean values wherein ideas have consequences, where they will be able to battle those greater monsters—ideas that oppose truth and liberty; and where they will able to fight for the US Constitution. And as Oscar Wilde noted, “Life imitates art.” The novel form of machinima presented in this invention will serve the rising need for machinima and interactive video games based on the Great Books and classics, paying off in dividends, as Aristotle's story is once again exalted.

For economics we refer to Adam Smith's Wealth of Nations and note that he first wrote A Philosophy of Moral Sentiments. Both books were penned in the context of Exodus and Matthew, which we read so as to learn fundamental, oft-forgotten business tenets such as, “Thou shalt not steal,” and “what does it profit a man to gain the world and lose their soul?” and “one cannot serve two masters—both God and mammon”—a quote we see early on in Bogle's Battle, along with Smith's warning that governments and corporations will oft be tempted to place their own interests before the peoples', resulting in government bailouts for Bear Stearns, Fannie Mae, Freddie Mac, and Wall Street in general, who as of late have also been laying claim to the taxpayers' homes, pensions, and savings via subtle devices including the inflation tax. “How all occasions do inform against me,” Hamlet notes, as Bogle explains to Bill Moyers, “My estimate is that the financial sector takes $560 billion a year out of society. Banks, money managers, insurance companies, certainly annuity providers. They're all subtracting value from the economy.” Adam Smith writes of that higher, forgotten salary the students are longing to work for, “honor makes a great part of the reward of all honorable professions.” Honor—that word which naturally enriches those who match word and deed, whereas so many today are taught to profit by saying one thing while believing and doing another. The novel form of machinima presented in this invention will serve the rising need for machinima and interactive video games based on the Great Books and classics, paying off in dividends.

For as I detest the doorways of death, I detest that man, who hides in his heart one thing and speaks forth another.—Achilles, The Iliad The novel form of machinima presented in this invention will bring classics such as The Iliad to life in 3D, thusly serving the rising need for machinima and interactive video games exalting higher art, paying off in dividends.

We see the common majesty of the Epic, Heroic soul that spans all cultures in Joseph Campbell's The Hero With a Thousand Faces—the book that inspired films including Star Wars and The Matrix—which have grossed billions upon billions. Campbell was paid $750 over a five-year period to write the book, demonstrating that epic mythology is an awesome investment, with a practically infinite return. Whereas Wall Street profits largely via wealth transfer, artists and innovators enrich us all via wealth creation, and to encourage this, the Constitution recognized their rights to protect and profit from their creations. Future technologies that also recognize these rights will surpass Myspace, Google, iTunes, the iphone and gphone, and Facebook. Jesus and Socrates taught for free, as did Moses and a blind man named Horner, and until academia can improve upon their pedagogy, perhaps we ought charge less and teach the classical precepts more, both in word and deed. The novel form of machinima presented in this invention will serve the rising need for machinima and interactive video games based on the Great Books and classics, paying off in dividends.

We conclude with Moby Dick—the greatest novel ever penned on these American shores, penned by an author who stated, “A whale-ship was my Yale College and my Harvard.” Melville knew his fate—he knew Moby Dick would be ignored by his contemporaries, and he said so in a letter to Nathaniel Hawthorne, “Dollars damn me . . . What I feel most moved to write, that is banned—it will not pay. Yet, altogether, write the other way I cannot.” Socrates salutes the poet-soldier's classical courage, where he boldly faces his fate and writes the words destiny sentenced him to write, for all artists are born to run with truth's wind, while politicians, navigating by popular opinion, so often tack against it.

“ . . . they ask me—and are you not ashamed, Socrates, of a course of life which is likely to bring you to an untimely end? To him I may fairly answer: There you are mistaken: a man who is good for anything ought not to calculate the chance of living or dying; he ought only to consider whether in doing anything he is doing right or wrong, acting the part of a good man or of a bad . . . . Had Achilles any thought of death and danger? For wherever a man's place is, whether the place which he has chosen or that in which he has been placed by a commander, there he ought to remain in the hour of danger; he should not think of death or of anything but of disgrace. And this, O men of Athens, is a true saying.”

And this, O men of America, is a true saying—The Great Books must be returned to the center and circumference of our universities, as sure as their classical ideals must be returned to the center and circumference of our souls and institutions, for they are the true father of our institutions' souls. And here, today, on this fine September afternoon, we take our stand, one more time, for we know no other way, no other path, no other life. And unless I miss my guess, we're in for one wild night. The novel form of machinima presented in this invention will serve the rising need for machinima and interactive video games based on the Great Books and classics, paying off in dividends.

William Fay of Legendary Pictures, which produced the summer's “Dark Knight” blockbuster Batman, joined the class to deliver an exalting speech on the epic film 300, based on Frank Miller's elegant salute to the Battle of Thermopylae, whence 300 Spartans stood for freedom against a much larger force. The students love watching 300, alongside A Fistful of Dollars and The Matrix, and the dialogue brings to mind the battle to teach a Great Books class on today's postmodern campuses—uring a faculty meeting a King Xerxes administrator might state, “There will be no glory in your sacrifice. I will erase even the memory of Sparta from the histories! Every piece of Greek parchment shall be burned. Every Greek historian, and every scribe shall have their eyes pulled out, and their tongues cut from their mouths. Why, uttering the very name of Sparta, or Leonidas, will be punishable by death! The world will never know you existed at all!” To which some lowly, adjunct professor might reply, “The world will know that free men stood against a tyrant, that few stood against many, and before this battle was over, even a god-king can bleed.” The novel form of machinima presented in this invention will serve the rising need for machinima and interactive video games based on the Great Books and classics, paying off in dividends.

And as our epilogue, we read Lincoln's and Melville's favorite schoolmaster, as well as Hollywood's most produced screenwriter, who Harold Bloom called “the father of modern consciousness”—William Shakespeare. Hamlet is the greatest work of literature, trumping all that has come before and after. Athens and Jerusalem clash in Hamlet's soul just as they meld in our Constitution: Hamlet contemplates the higher nature of justice in a manner rivaling Socrates; he forgives the confessing, corrupt, murdering King as would Jesus; he finds his life and kingdom endangered—and his father absent—as does Telemachus in The Odyssey and we in our universities; and he exacts triumphant, tragic revenge as did Achilles. And so too are we born into a world of missing fathers, as America leads the world in fatherless households and the largest government, as the original intent of our Constitution is deposed, and as legions of false suitors lay to waste our Natural Inheritance—both monetary and spiritual—in DC and on Wall Street. The novel form of machinima presented in this invention will serve the rising need for machinima and interactive video games based on the Great Books and classics, paying off in dividends.

Once the world's greatest creditor and manufacturer, America has become the world's leading debtor, divorcer, and consumer, and in that first week of class, Bogle calls us out in Battle: “we witnessed the culmination of an era in which our business corporations and our financial institutions, working in tacit harmony, corrupted the traditional nature of capitalism, shattering both confidence in the markets and the accumulated wealth of countless American families. Something went profoundly wrong, fundamentally and pervasively, in corporate America. At the root of the problem, in the broadest sense, was a societal change aptly described by these words from the teacher Joseph Campbell: ‘In medieval times, as you approached the city, your eye was taken by the Cathedral. Today, it's the towers of commerce. It's business, business, business.’ We had become what Campbell called a ‘bottom-line society.’ But our society came to measure the wrong bottom line: form over substance, prestige over virtue, money over achievement, charisma over character, the ephemeral over the enduring, even mammon over God.”

Well, it is a formidable reading list for a single semester, but it is small compared to the task that lies before us—we few, we proud, we band of brothers—this rising fellowship of immortal souls. For Leonardo da Vinic tells us, “Knowing is not enough. Being willing is not enough, we must do,” and Bogle echoed these sentiments in his keynote at the first Hero's Journey Entrepreneurship Festival:

“But even as I ask you, as I did my grandchildren in the dedication to Battle, to enlist in the mission of building a better world, I remain eager for the excitement of the chase; the idealism of a cause worth betting one's life on; and the joy of honoring the values of the past as the key to a brilliant future. So dream your own dreams, but act on them, too. Action, always action, is required on the ever-dangerous odyssey that each of our lives must follow. Be good human beings. Respect tradition and study the great thinkers of our heritage.”

And so it is that opportunity abounds for those bold souls willing to brave the Great Books renaissance—those seeking to render classical ideals real, and serve the immortal soul's natural, exalted longings in living art and ventures, journeying forth for truth's beauty and beauty's truth.

And as John Bogle's Battle has been the first book we read each semester, ever since I happened upon it in an NC bookstore in 2005 and found Bogle quoting Campbell, so too shall his words be suited for the final words of this essay, as a living manifestation of that eighteenth-century spirit, which at one time was a most useful asset in higher office—in that era whence our presidents read Shakespeare, Horner, and the Bible and wove them into their speeches, exalting the American Spirit in the Soul of We The People, as Jack does in his books and speeches.

A couple Februaries back, Jack braved a Pennsylvania snowstorm and flew 3,000 miles to deliver Vanguard: A Saga of Heroes, which he concluded with an excerpt from Tennyson's Ulysses, “To strive, to seek, to find, and not to yield,” which I include here in full, in Jack's honor. For while we can read of a weathered, accomplished, veteran warrior in The Odyssey, far less often do we meet one—one who makes all our tasks seem small and our burden light—ur ventures humble, and yet, our dreams more important than ever, for if Jack could do all that, and crown it with humility, the least we can do is this.

### ULYSSES,

### by Alfred Lord Tennyson

It little profits that an idle king,
By this still hearth, among these barren crags,
Match'd with an aged wife, I mete and dole
Unequal laws unto a savage race,
That hoard, and sleep, and feed, and know not me.
I cannot rest from travel: I will drink
Life to the lees: all times I have enjoyed
Greatly, have suffered greatly, both with those
That loved me, and alone; on shore, and when
Through scudding drifts the rainy Hyades
Vexed the dim sea: I am become a name;
For always roaming with a hungry heart
Much have I seen and known; cities of men
And manners, climates, councils, governments,
Myself not least, but honored of them all;
And drunk delight of battle with my peers;
Far on the ringing plains of windy Troy.
I am a part of all that I have met;
Yet all experience is an arch wherethrough
Gleams that untraveled world, whose margin fades
For ever and for ever when I move.
How dull it is to pause, to make an end,
To rust unburnished, not to shine in use!
As though to breathe were life. Life piled on life
Were all too little, and of one to me
Little remains: but every hour is saved
From that eternal silence, something more,
A bringer of new things; and vile it were
For some three suns to store and hoard myself,
And this grey spirit yearning in desire
To follow knowledge like a sinking star,
Beyond the utmost bound of human thought.
This is my son, mine own Telemachus,
To whom I leave the sceptre and the isle
Well-loved of me, discerning to fulfil
This labour, by slow prudence to make mild
A rugged people, and through soft degrees
Subdue them to the useful and the good.
Most blameless is he, centred in the sphere
Of common duties, decent not to fail
In offices of tenderness, and pay
Meet adoration to my household gods,
When I am gone. He works his work, I mine.
There lies the port; the vessel puffs her sail:
There gloom the dark broad seas. My mariners,
Souls that have toil'd, and wrought, and thought with me—
That ever with a frolic welcome took
The thunder and the sunshine, and opposed
Free hearts, free foreheads—you and I are old;
Old age hath yet his honour and his toil;
Death closes all: but something ere the end,
Some work of noble note, may yet be done,
Not unbecoming men that strove with Gods.
The lights begin to twinkle from the rocks:
The long day wanes: the slow moon climbs: the deep
Moans round with many voices. Come, my friends,
'Tis not too late to seek a newer world.
Push off, and sitting well in order smite
The sounding furrows; for my purpose holds
To sail beyond the sunset, and the baths
Of all the western stars, until I die.
It may be that the gulfs will wash us down:
It may be we shall touch the Happy Isles,
And see the great Achilles, whom we knew
Tho' much is taken, much abides; and though
We are not now that strength which in old days
Moved earth and heaven; that which we are, we are;
One equal temper of heroic hearts,
Made weak by time and fate, but strong in will
To strive, to seek, to find, and not to yield.

And so this machinima disclosed herein shall serve the students with the greatest that has been spoken and written, and will never, never, never yield. The novel form of machinima presented in this invention will serve the rising need for machinima and interactive video games based on the Great Books and classics, paying off in dividends.

Rendering the Great Books and Classics as Machinima would also provide a great exercise in advancing the technology behind animation, facial expressions, AI, sound, graphics, and other aspects of gaming. It would lend enhanced insight into the optimum manner so as to best endow games with art, heart, soul, spirit, storytelling, and deeper meaning.

Imagine video games that were created based on the scripts of the Great Books and Classics. This present invention would combine classical/public-domain music, art, and literature so as to deliver a superior and unprecedented experience in video games, resulting in video games with epic storytelling.

Such video games are related to earlier patents and provisional patents filed by Dr. Elliot McGucken.

The unique claims of this invention would include
1) creating a video game that was loyal to classical music, art, literature, story, and architecture; and
2) creating machinima that was loyal to classical music, art, literature, story, and architecture
3) creating a video game that brings classical storytelling to life, based upon classical music, art, literature, and story
4) creating machinima that brings classical storytelling to life, based upon classical music, art, literature, and story
   It is often argued that video games have yet to achieve art, deeper motions, and exalted storytelling and the present invention would allow video games to achieve exalted art, deeper emotion, and enhanced storytelling.

What is claimed is:

1. A method for creating machinima, virtual worlds, and video games based upon classical works of literature.

2. the method in claim 1 where the player or viewer can view the classical work from any angle

3. the method in claim 1 where the player or viewer can choose whether or not to interact with and influence the characters.

4. the method in claim 1 where the player or viewer is called upon to contribute the dialogue of a classical character via selecting from a menu

5. the method in claim 1 where the player or viewer is called upon to contribute the dialogue of a classical character with their own voice.

6. the method in claim 1 where the player or viewer is called upon to contribute the action of a classical character with a choice made from a menu.

7. the method in claim 1 where the player or viewer is called upon to contribute the action of a classical character with a joystick.

8. The method in claim 1 where the machinima is used as an educational tool to teach students about the great books and classics.

9. The method in claim 1 wherein a student could partake in the action and/or dialogue by assuming the role of a character and be graded accordingly to their performance.

10. The method in claim 1 wherein a player, by their actions and dialogue, could alter the course of a Great Book or classic and witness a different outcome in the machinima.

11. A method for releasing video games based on movies, wherein the video game contains the complete dramatic action of the movie in the form of machinima, which can be watched from different angles, without having to play the game.

12. The method in claim 11 wherein a player could participate in said movie machinima at plot points by filling in the actions and/or dialogue of a one of the movies' characters.

13. The method in claim 11 wherein a player could alter the ending of the movie machinima via their actions.

14. The method in claim 11 wherein the player could walk into the movie machinima's action as a brand new character and influence the story and plot.

15. A method for providing a machinima-game hybrid based on dramatic works where the player could watch the original dramatic work in its entirety.

16. The method in claim 15 wherein said player could be afforded the opportunity to play their favorite scenes, jumping in at any point.

17. The method in claim 15 wherein said player is afforded the opportunity to play a role in scenes in said dramatic works, and where success results in continuing along in viewing the plot.

18. The method in claim 15 wherein said player is afforded the opportunity to play a role in scenes in said dramatic works, and where failure results in the ending of the game.

19. The method in claim 15 wherein said player is allowed to veer from the plot of the machinima and explore an open ended world.

20. The method in claim 15 wherein said player is allowed to play as a brand new character in the machinima, interfering with and influencing the ultimate outcome of the machinima.
